(19) United States
(12) Patent Application Publication
(10) Pub. No.: US 2026/0252318 A1
(43) Pub. Date: Aug. 27, 2026

(54) Application Function Execution System

(71) Applicant: Litexn LLC, Ashburn, VA (US)

(72) Inventor: Bharatkumar Chovatiya, Ashburn, VA (US)

(73) Assignee: Litexn LLC, Ashburn, VA (US)

(21) Appl. No.: 19/059,536

(22) Filed: Feb. 21, 2025

(51) Int. Cl. G06F 8/35; G06F 9/451

(52) U.S. Cl. CPC G06F 8/35; G06F 9/451

(57) ABSTRACT

An application function execution system includes an application, a user interface receiving a natural language input from a user, a controller connected to the user interface and the application, and an AI system connected to the controller. The controller receives the natural language input. The controller sends a formatted input to the AI system that is representative of the natural language input. The AI system generates an action sequence based on the formatted input and generates a code for the application corresponding to the action sequence. The controller receives the code from the AI system and executes the code on the application to perform a function on the application that corresponds to the natural language input.

### FIELD OF THE INVENTION

The present invention relates to a system that includes an application and, more particularly, to a system that executes a function on the application in response to a user input.

### BACKGROUND

Software applications are becoming increasingly sophisticated for a variety of business and consumer applications. However, as these applications become more powerful and have increased functionality, they also become more complex. There is an extensive learning curve to leverage the most powerful and useful aspects of these applications, which requires technical ability, specialized knowledge, and significant, time-consuming training. Consequently, although these sophisticated applications are essential in ultimately improving efficiency of task performance or making entirely new functions available to the user, learning to use the applications in this optimal manner can be an inefficient process. Further, attempting to use such complex software without fully learning the inputs and functionality can lead to errors or inconsistencies in the application output that may be undetectable to the user.

### SUMMARY

An application function execution system includes an application, a user interface receiving a natural language input from a user, a controller connected to the user interface and the application, and an AI system connected to the controller. The controller receives the natural language input. The controller sends a formatted input to the AI system that is representative of the natural language input. The AI system generates an action sequence based on the formatted input and generates a code for the application corresponding to the action sequence. The controller receives the code from the AI system and executes the code on the application to perform a function on the application that corresponds to the natural language input.

### BRIEF DESCRIPTION OF THE DRAWINGS

The invention will now be described by way of example with reference to the accompanying Figures, of which:

FIG. 1 is a block diagram of an application function execution system according to an embodiment;

FIG. 2 is a flowchart of a first portion of a process of using the application function execution system;

FIG. 3 is a flowchart of a second portion of the process of using the application function execution system;

FIG. 4 is a flowchart of a third portion of the process of using the application function execution system;

FIG. 5 is a flowchart of a fourth portion of the process of using the application function execution system;

FIG. 6 is a schematic diagram of a user interface and an application of the application function execution system prior to inputting a natural language input;

FIG. 7 is a schematic diagram of the user interface and the application after a function is performed on the application with the application function execution system; and

FIG. 8 is a schematic diagram of a pair of exemplary action sequences generated by an AI system of the application function execution system.

### DETAILED DESCRIPTION OF THE EMBODIMENTS

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In addition, in the following detailed description, for purposes of explanation, numerous specific details are set forth to provide a thorough understanding of the disclosed embodiments. However, it is apparent that one or more embodiments may also be implemented without these specific details.

Throughout the drawings, only one of a plurality of identical elements may be labeled in a figure for clarity of the drawings, but the detailed description of the element herein applies equally to each of the identically appearing elements in the figures.

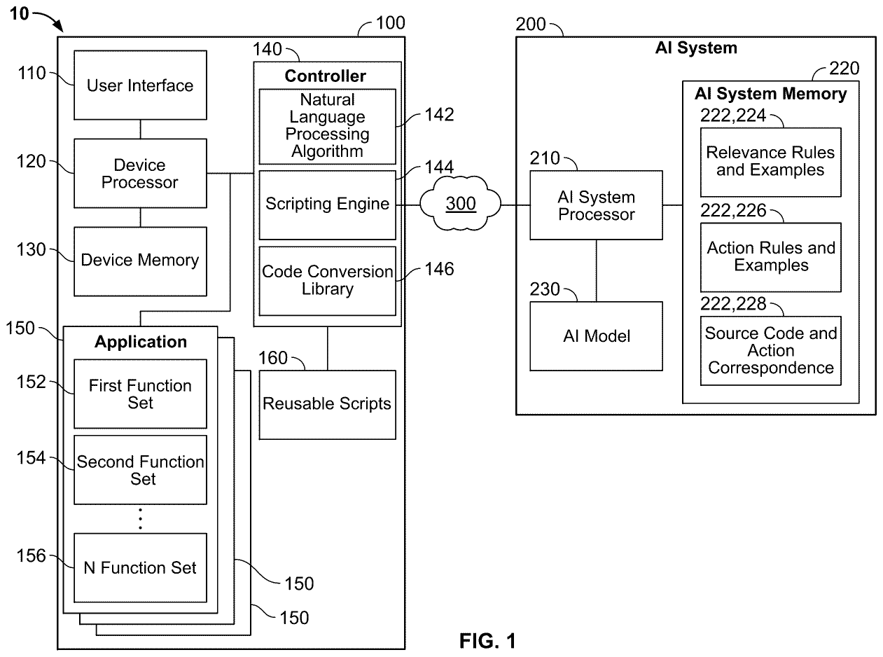

An application function execution system 10 according to an embodiment is shown in FIG. 1. The application function execution system 10 includes a computing device 100 and an AI system 200 connected to the computing device 100 by a network 300. The network 300 may be a local area network (LAN), a wide area network (WAN) such as a connection through the Internet, or any other type of network connection.

In the embodiment shown in FIG. 1, the computing device 100 includes a user interface 110, a device processor 120 connected to the user interface 110, and a device memory 130 connected to the device processor 120. The computing device 100 may be a computer, such as a laptop or a desktop computer, a mobile device, such as a smartphone, or any other type of computing device capable of performing the functions of the computing device 100 described herein.

The user interface 110 includes at least one input element and at least one output element. The input element may be a microphone, a keyboard, a touch screen, or any other type of element that is used to input data to a computing device. The output element may be a speaker, a display screen, or any other type of element that is used to output date to a computing device.

The device processor 120 on the computing device 100 may be any type of central processing unit (CPU), Advanced RISC Machine (ARM), application-specific integrated circuit (ASIC), or any other type of processor incorporated in a computing device 100 that is capable of performing the functions of the device processor 120 described herein. The device memory 130 is a non-transitory computer-readable medium, such as random-access memory (RAM) or read-only memory (ROM), storing a plurality of algorithms thereon that, when executed by the device processor 120, perform the functions of the device processor 120 described herein. The device memory 130 can also store other data in addition to the executable algorithms.

In the embodiment shown in FIG. 1, the computing device 100 includes a controller 140 connected to the device processor 120. In this embodiment, the controller 140 uses the device processor 120 to execute the functions of the controller 140 described herein. In other embodiments, the controller 140 is part of a separate device, such as a server, that communicates with the computing device 100 over the network 300. In these embodiments, the controller 140 has its own processor and memory similar to the device processor 120 and the device memory 130.

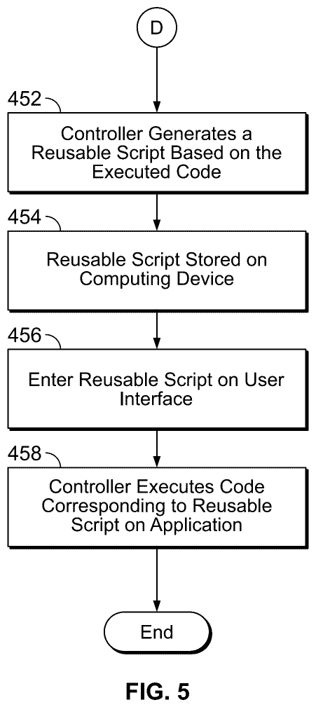

The controller 140, as shown in FIG. 1, includes a natural language processing algorithm 142, a scripting engine 144, and a code conversion library 146. The natural language processing algorithm 142 may be any type of natural language processing algorithm, such as a latent Dirichlet allocation (LDA) algorithm, a conditional random fields (CRF) algorithm, a porter stemmer algorithm, a hidden Markov model (HMM), or any other type of algorithm executable by the device processor 120 to receive an input in natural language and translate the input into a format readable by computing devices. The scripting engine 144 is a series of instructions that perform the steps shown in FIG. 5 and described in detail below. The code conversion library 146 is a stored relationship between code that is output by the AI system 200 and (a) a user format of the code that is understandable by the user, and (b) code that is executable by an application 150 on the computing device 100.

The computing device 100, as shown in FIG. 1, has at least one application 150 stored thereon. The application 150 may be redaction software that a user can use to redact portions of documents or may be any other type of complex software application that requires significant time to learn the inputs and menus to fully leverage the functionality of the application, such as photo or video editing software, or computer-aided design (CAD) software.

In the shown embodiment, the computing device 100 has a plurality of such applications 150 stored thereon. Each of these applications 150, regardless of its particular purpose, has a series of functions: a first function set 152, a second function set 154, and further function sets up to an N function set 156 based on the particular application 150. An application 150 for document redaction, for example, may have a first function set 152 related to redacting portions of a document, may have a second function set 154 related to unredacting portions of a document, and may have further function sets up to the N function set 156, for example related to searching the document for certain elements. An application 150 for photo editing, for example, may have a first function set 152 related to altering the lightness of an image, may have a second function set 154 related to altering the colors of an image, and may have further function sets up to N function set 156, for example related to selecting portions of the image, erasing portions of the image, etc. The function sets 152, 154, 156 are all the various functions capable of being performed by the various applications 150.

The AI system 200, as shown in FIG. 1, includes an AI system processor 210, an AI system memory 220 connected to the AI system processor 210, and an AI model 230 connected to the AI system processor 210. The AI system 200 may be embodied as a server that includes the AI system processor 210, the AI system memory 220, and the AI model 230. In the embodiment shown in FIG. 1, the AI system 200 is connected to the computing device 100 by the network 300. In another embodiment, the AI system 200 can be part of a single computing device 100 with the user interface 110, the controller 140, and the applications 150.

The AI system processor 210 may be any type of central processing unit (CPU), Advanced RISC Machine (ARM), application-specific integrated circuit (ASIC), or any other type of processor that is capable of performing the functions of the AI system processor 210 described herein.

The AI model 230 may be any type of available AI model or may be a custom-built AI model. In an embodiment, the AI model 230 is an open-source AI model, such as Llama. In another embodiment, the AI model 230 may be a closed-source AI model, such as ChatGPT or Gemini. The AI model 230 is connected to the AI system processor 210 and executed by the AI system processor 210 to perform the functions of the AI system 200 described in detail below.

The AI system memory 220 is a non-transitory computer-readable medium, such as random-access memory (RAM) or read-only memory (ROM). The AI system memory 220 is connected to the AI system processor 210 and stores a plurality of data 222 that the AI system processor 210 uses to train the AI model 230. The plurality of data 222 is particular to the functions of the specific application 150 that is controlled by the application function execution system 10. The plurality of data 222 includes a plurality of relevance rules and examples 224 that corresponds to a plurality of actions that are relevant to the application 150; the relevance rules and examples 224 allow the AI model 230, when executed by the AI system processor 210, to determine what input data is related to particular actions of the application 150 and what input data is not related to particular actions of the application 150. The plurality of data 222 includes a plurality of action rules and examples 226 that allow the AI model 230, when executed by the AI system processor 230, to identify specific series of actions particular to the function sets 152, 154, 156 of the application 150, address conflicts between the various actions of the application 150, and standardize terminology related to the actions of the application 150. The plurality of data 222 further includes a source code and action correspondence 228 that correlates a source code with the actions of the application 150. The plurality of data 222 used to train the AI model 230 within the AI system 200 will be described in further detail below.

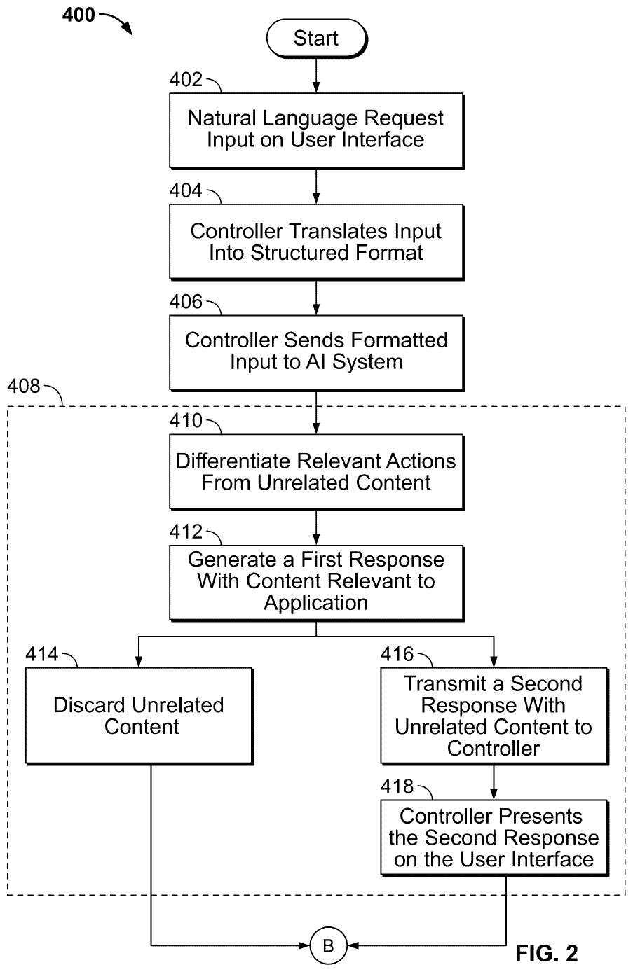

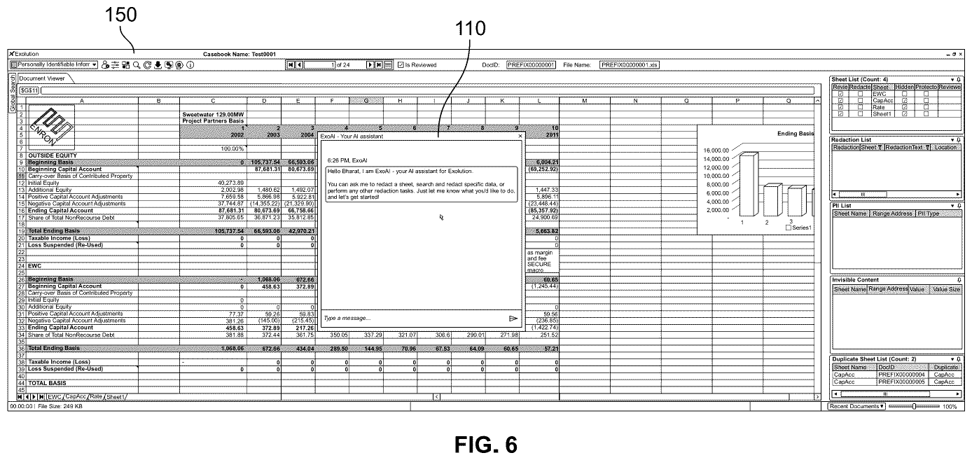

A process 400 of using the application function execution system 10 to execute functions of the function sets 152, 154, 156 on the application 150 will now be described in greater detail primarily with reference to FIGS. 2-5. The process 400 will be described, by way of example, with reference to a document redaction application 150, as shown in FIGS. 6-8. The present disclosure is not limited to the embodiment of the application 150 as a document redaction application and, as described above, applies equally to any type of complex application 150 that requires significant time to learn to fully leverage functionality.

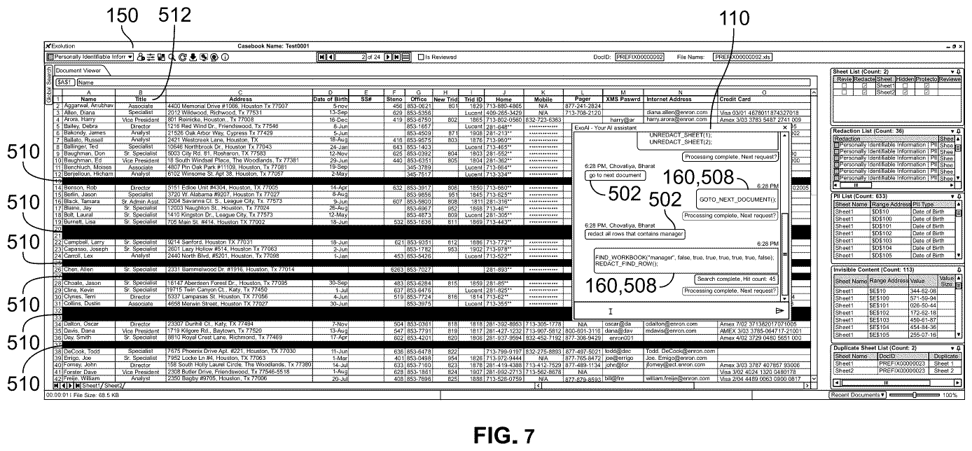

An exemplary user interface 110 is shown in FIGS. 6 and 7. In FIGS. 6 and 7, the application 150, in this example the document redaction application 150, is shown with the user interface 110, as it could be presented to the user on the computing device 100. In this document redaction example, the application 150 has a plurality of sheets and a plurality of cells on the sheets that each contain text, numbers, portions of a graph, or any other elements common to a worksheet. In other embodiments, the document redaction application 150 could be used with document types other than worksheets, such as text documents or PDFs.

In a step 402 of the process 400, shown in FIG. 2, the user interface 110 receives a natural language input 502 from the user. The natural language input 502 is an instruction from the user to perform a function of the function sets 152, 154, 156 on the application 150. In the document redaction example, as shown in FIG. 7, the natural language input 502 is a text input from the user that specifies “go to next document” or “redact all rows that contain manager”; instructions that correspond to particular functions of the application 150. In other embodiments, the natural language input 502 could be an audio input, for example by recording the user with a microphone of the computing device 100. Whether the natural language input 502 is text or audio, the natural language input 502 can be in any one of a plurality of different languages, such as English, Spanish, French, Korean, Japanese, etc, all of which can be understood and processed by the application function execution system 10.

In a step 404 of the process 400, the controller 140 receives the natural language input 502 from the user interface 110 and uses the natural language processing algorithm 142 to translate the natural language input 502 into a formatted input. The natural language processing algorithm 142 is executed by the device processor 120 and, with the natural language input 502 as an input, outputs a formatted input that is representative of the natural language input 502, but is in a format that can be understood by computing devices.

In a step 406, the controller 140 sends the formatted input representative of the natural language input 502 to the AI system 200. In an embodiment, in the step 406, the controller 140 can also send the relevance rules and examples 222, 224 to the AI system 200 with the formatted input. In another embodiment, as described above, the AI model 230 and the AI system 200 can be pre-trained with the relevance rules and examples 222, 224.

As shown in FIG. 2, after receiving the formatted input from the controller 140, the AI system 200 executes an input analysis block 408 that includes a series of steps.

In a step 410, the AI system 200, with the AI model 230 trained with the relevance rules and examples 222, 224 and executed on the AI system processor 210, differentiates relevant actions from unrelated content in the formatted input. In the document redaction example, the AI system 200 identifies a first portion or plurality of first portions of the formatted input related to functions like “redact”, “unredact”, or any of the other of the function sets 152, 154, 156 of the application 150 by comparing the formatted input to the relevant actions of the application 150 trained in the relevance rules and examples 224. The AI system 200 is able to identify variants of the relevant functions described in the formatted input through the relevance rules and examples 222, 224; for example, identifying that “create redaction” and “apply redaction” also correspond to the “redact” function of the application 150. In a step 412, shown in FIG. 2, the AI system 200 generates a first response that includes the first portion of the formatted input that is relevant to the application 150.

The AI system 200 further identifies in the step 410 a second portion or plurality of second portions of the formatted input that do not relate to any functions or actions of the function sets 152, 154, 156 of the application 150. In an embodiment, the AI system 200 discards the second portion of the formatted input as unrelated content in a step 414. In another embodiment, the AI system 200 transmits a second response containing the second portion or plurality of second portions of the formatted input to the controller 140 in a step 416. The controller 140, in a step 418, can present or display the second response, including the portion of the formatted input corresponding to the natural language input 502 that is not relevant to the functions of the application 150, on the user interface 110 to inform the user on which portions of the natural language input 502 were not used for determining actions.

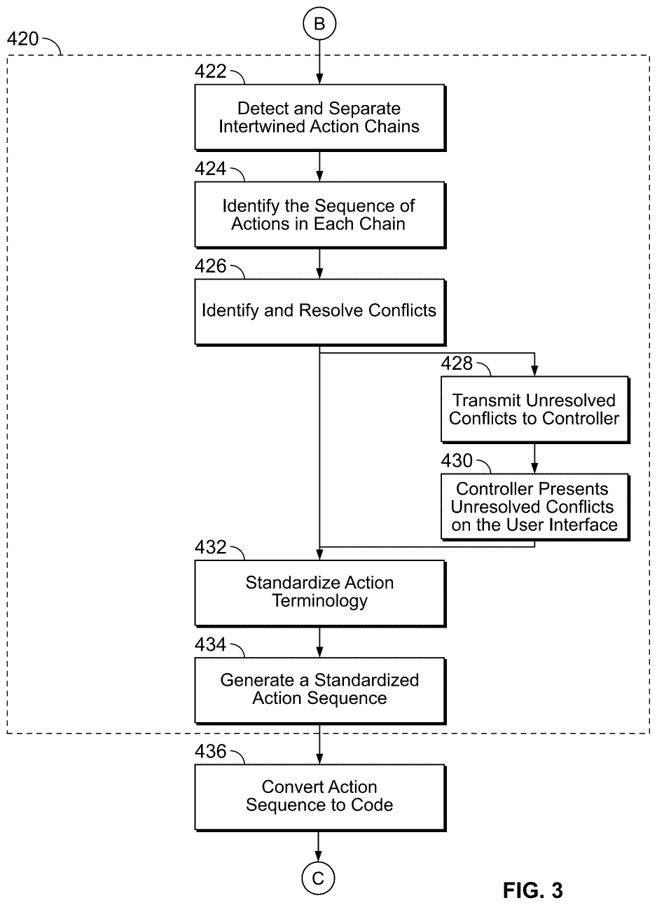

As shown in FIG. 3, after generating the first response that includes the first portion of the formatted input that is relevant to the application 150, the AI system 200 executes an action sequencing block 420 that includes a series of steps.

In a step 422 shown in FIG. 3, the AI system 200, with the AI model 230 trained with the action rules and examples 222, 226 and executed on the AI system processor 210, detects and separates intertwined chains of actions of the first portion of the formatted input that correspond to functions of the application 150. The action rules and examples 222, 226 correspond to connected series of actions of the application 150, training the AI model 230 to detect these series of actions, and potentially multiple series of actions, contained with the natural language input 502.

The AI system 200 detects and separates the discrete series of actions in the step 422 and identifies the separated sequences of actions of the first portion of the formatted input in a step 424. In the document redaction example, for a natural language input 502 of “redact all rows except rows containing Analyst” (see for example the data in the application of FIG. 7) the AI system 200 may identify a sequence of actions such as (1) searching for the term “Analyst”, (2) redacting row containing that term, and (3) then applying an inverse redaction to redact all rows except the rows containing Analyst. The AI system 200 can perform this step 424 by executing the AI model 230 trained with the action rules and examples 222, 226 specific to the application 150 for each of the sequences of actions pertaining to functions of the application 150 that are contained in the natural language input 502.

In a step 426 shown in FIG. 3, the AI system 200 executes the AI model 230 trained with the action rules and examples 222, 226 to identify and resolve conflicts between the action sequences contained within the first portion of the formatted input. For example, the AI system 200 may identify the actions “redact row 13” and “unredact row 13” in the action sequences and determine that a conflict exists. If no conflict exists, the AI system 200 proceeds as described below. If the AI system 200 is able to resolve conflict based on the action rules and examples 222, 226, for example determining that the “redact row 13” and “unredact row 13” actions are intended for different sheets, the AI system 200 resolves the conflict and proceeds as described below. If an unresolvable conflict exists, the AI system 200 can transmit unresolved conflicts to the controller 140 in a step 428, and the controller 140 can present or display the unresolved conflicts on the user interface 110 in a step 430 to inform the user. The user is then aware of which portions of the natural language input 502 were not understood by the AI system 200 or were presented incorrectly.

In a step 432, the AI system 200 takes the action sequences surviving the conflict analysis in step 426 and standardizes the terminology of the actions based on the action rules and examples 222, 226. For example, the AI system 200 can replace terminology from the natural language input 502 such as “delete redaction”, “remove redaction”, or other variations with the standardized action “unredact”. The standardized terminology can be applied to all the actions pertaining to all the function sets 152, 154, 156 of the application 150.

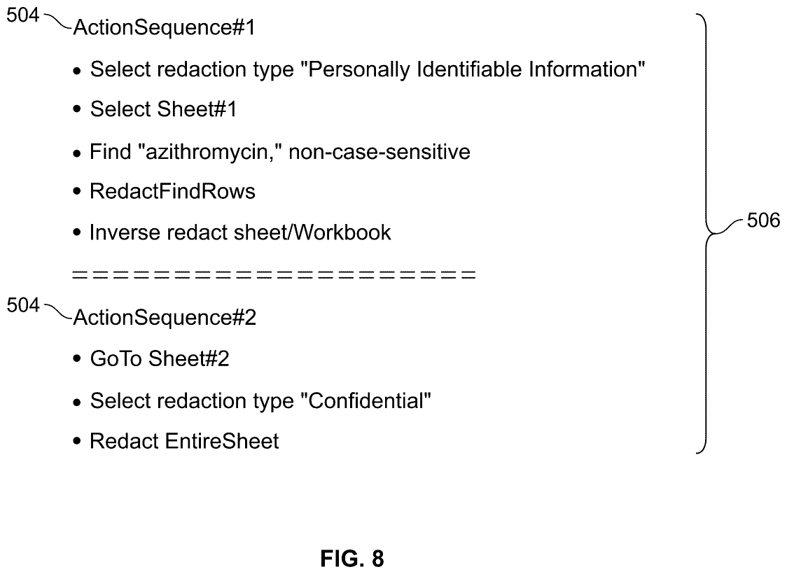

In a final step 434 of the action sequencing block 420 shown in FIG. 3, the AI system 200 executes the AI model 230 trained with the action rules and examples 222, 226 to generate an action sequence 504 based on the formatted input that was identified in step 424, determined to not conflict in step 426, and has standardized action terminology from step 432. Two exemplary action sequences 504 resulting from the natural language input 502 for the document redaction embodiment are shown in FIG. 8. In a first exemplary action sequence 504, for example for the natural language input 502 of “redact all rows that do not contain azithromycin”, the action sequence 504 has four standardized, non-conflicting steps of (1) selecting a redaction type, (2) selecting a particular sheet, (3) finding the term specified in the natural language input 502, (4) redacting all rows containing the term, and (5), applying an inverse redaction to redact everything except the rows containing the term. In a second exemplary action sequence 504, for example for the natural language input 502 of “redact the sheet”, the action sequence 504 has three standardized, non-conflicting steps of (1) selecting a particular sheet, (2) selecting a redaction type, and (3) redacting the entire sheet.

The multiple action sequences 504 shown in the example of FIG. 8 may be generated in the step 434 by the AI system 200 in response to a single natural language input 502. For example, the multiple action sequences 504 shown may be generated from the natural language input 502 of “redact all rows that do not contain azithromycin on this sheet, then redact the next sheet”. The AI system 200 can process and generate multiple action sequences corresponding to the application 150 based on the natural language input 502.

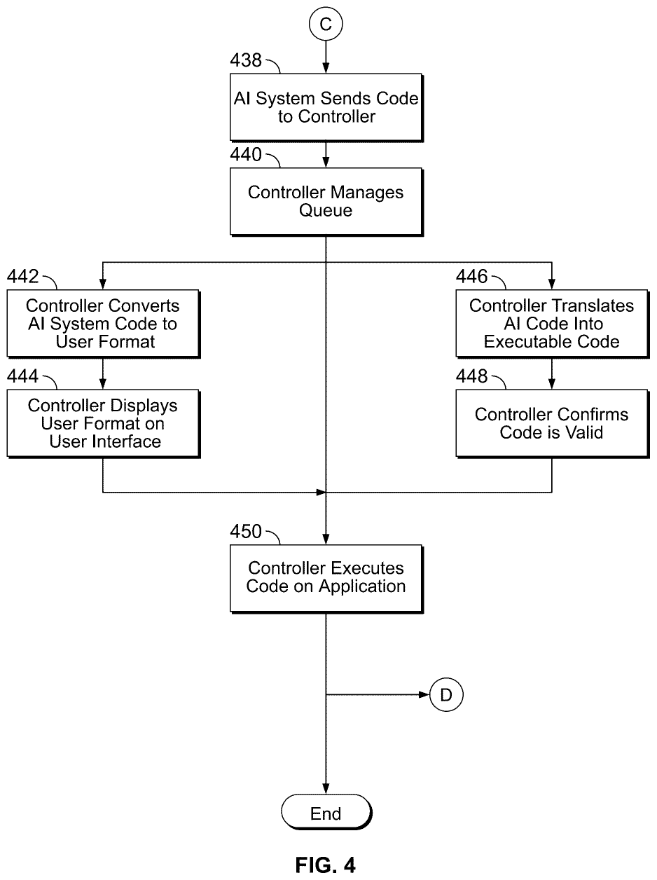

In a step 436 shown in FIG. 3, the AI system 200 executes the AI model 230 trained with the source code and action correspondence 228 to convert action sequence 504 to a code for the application 150. The source code and action correspondence 228 correlates the actions in the action sequences 504 with particular code of the application 150 used to execute the actions in the action sequences 504 and generates the appropriate code for the application 150 corresponding to the action sequence 504 based on the source code and action correspondence 228. In a step 438 shown in FIG. 4, the AI system 200 sends the code corresponding to the action sequence 504 to the controller 140.

In a step 440 shown in FIG. 4, if the code sent to the controller 140 contains multiple action sequences 504, the controller 140 can manage a queue 506 of the action sequences 504. An exemplary queue 506 of two action sequences 504 receives at the controller 140 is shown in FIG. 8. The controller 140 executes the action sequences 504 on the application 150, as described below, in the queue 506 in a sequence received; executing the first action sequence 504 first and the second action sequence 504 in the example of FIG. 8 second.

In an embodiment, as shown in FIG. 4, the controller 140 can convert the code from the AI system 200 into a user format 508 that is understandable by the user in a step 442. The controller 140 executes the code conversion library 146 with the device processor 120 to correlate the code output by the AI system 200 to the user format 508 that is understandable by the user. The controller 140, in a step 444, can display the user format 508 on the user interface 110, as shown in FIG. 7. The user format 508, in the exemplary embodiment of the redaction software shown in FIG. 7, may be a command such as “GOTO_NEXT_DOCUMENT();” in response to the natural language input 502 of “go to next document”. The steps 442, 444 provide the user with some confirmation that the AI system 200 has performed its function. In other embodiments, the steps 442, 444 can be omitted.

In another embodiment, in a step 446 shown in FIG. 4, the controller 140 can translate the code from the AI system 200 into an executable code that is executable by the device processor 120 to perform functions in the application 150. The controller 140 executes the code conversion library 146 with the device processor 120 to correlate the code output by the AI system 200 to the executable code. In a step 448, the controller 140 can confirm that the converted executable code is valid by testing the execution of the code with the device processor 120; this step is optional. These steps 446, 448 are necessary if the code output from the AI system 200 is not directly executable by the processor 120 to perform the prescribed functions of the application 150. In other embodiments, the code from the AI system 200 in the step 438 may already be executable by the device processor 120 to perform the functions of the application 150 and, in this case, the steps 446, 448 can be omitted.

In a step 450 shown in FIG. 4, the controller 140 executes the code on the application 150, via the device processor 120, to perform the function of the function sets 152, 154, 156 on the application 150 that corresponds to the natural language input 502. In this step 450, the function specified by the user is performed on the application 150 as if the user had fully learned the necessary menus and other inputs to implement the function. For example, in the document redaction application 150 example shown in FIG. 7, the natural language input 502 is “redact all rows that contain manager” and, after the process described above, the controller 140 executes the code corresponding to this input on the application 150 to redact the rows 510 of the document in which the field in the “Title” column 512 contains the term “Manager”. Although this example is a simple function of a document redaction software, the application function execution system 10 can perform the process 400 in the same manner for significantly more complicated functions, with longer action sequences and more consecutive action sequences, and in applications 150 other than the document redaction software.

In another embodiment, the process 400 includes a series of steps shown in FIG. 5. In a step 452, the controller 140 generates a reusable script 160 based on the code that was executed on the application 150. In this step 452, the controller 140 executes the scripting engine 144, which correlates the code output by the AI system 200 with a script that is executable by the device processor 120 to perform the same function on the application 150 as the code. The script that is generated in the step 452 is the reusable script 160. As shown in FIG. 7, the reusable script 160 may be similar to the user format 508; the reusable script 160 for the natural language input 502 of “go to next document” may be “GOTO_NEXT_DOCUMENT();”. In a step 454, the controller 140 stores the reusable script 160 on the computing device 100, as shown in FIG. 1.

The reusable script 160 that is stored can then be retrieved and executed by the user. In a step 456 shown in FIG. 5, the user can retrieve and enter the reusable script 160 on the user interface 110. In a step 458, when the reusable script 160 is entered on the user interface 110, the controller 140 directly executes the reusable script 160 with the device processor 120 to perform the function corresponding to the reusable script 160 on the application 150 without communicating with the AI system 200 and without repeating all the steps of the process 400 described above.

The process 400 is described with respect to an embodiment in which functions of the function sets 152, 154, 156 are performed on a single application 150. In other embodiments, as shown in FIG. 1, the computing device 100 may have a plurality of applications 150 that perform different functions from one another and that each communicate with the controller 140 and the AI system 200. In these embodiments, the controller 140 can receive the natural language input 502 from the user and execute the code output from the AI system 200 on any one of the plurality of applications 150.

The application function execution system 10 eliminates the learning curve associated with using complex and sophisticated applications 150, allowing users to perform the functions of the applications 150 with just the natural language input 502 and without needing to spend the significant time and effort required to learn the intricacies of controlling the application 150. The application function execution system 10 consequently improves productivity and efficiency, allowing non-technical users to immediately leverage the functionality of the applications 150, while also avoiding the user error that can arise from a user's misunderstanding of the application 150 commands. The natural language input 502 in a variety of possible formats and languages makes the application function execution system 10 widely accessible. Further, the ability of the controller 140 to manage the queue 506 of action sequences 504 allows the user to input multiple functions that could each require significant time to execute, without requiring active user monitoring as the functions are performed. Additionally, the scripting engine 144 and the generation of the reusable scripts 160 allows the user to perform the same functions offline, independent of the connection to the AI system 200, which provides flexibility.

What is claimed is:

1. An application function execution system, comprising:
an application;
a user interface receiving a natural language input from a user;
a controller connected to the user interface and the application, the controller receives the natural language input; and
an AI system connected to the controller, the controller sends a formatted input to the AI system that is representative of the natural language input, the AI system generates an action sequence based on the formatted input and generates a code for the application corresponding to the action sequence, the controller receives the code from the AI system and executes the code on the application to perform a function on the application that corresponds to the natural language input.

2. The application function execution system of claim 1, wherein the AI system is trained on a plurality of data corresponding to the application.

3. The application function execution system of claim 2, wherein the plurality of data includes a plurality of relevance rules and examples corresponding to a plurality of actions that are relevant to the application.

4. The application function execution system of claim 3, wherein the controller transmits the relevance rules and examples to the AI system with the formatted input.

5. The application function execution system of claim 3, wherein the AI system generates a first response that includes a first portion of the formatted input corresponding to actions of the application and a second response corresponding to a second portion of the formatted input that does not correspond to actions of the application.

6. The application function execution system of claim 5, wherein the second response is discarded or presented on the user interface.

7. The application function execution system of claim 3, wherein the plurality of data includes a plurality of action rules and examples corresponding to connected series of the actions of the application, conflicts between the actions of the application, and terminology for the actions of the application.

8. The application function execution system of claim 7, wherein the AI system identifies the action sequence corresponding to the formatted input based on the action rules and examples.

9. The application function execution system of claim 8, wherein the AI system resolves conflicts between the actions in the formatted input based on the action rules and examples.

10. The application function execution system of claim 9, wherein the AI system transmits unresolved conflicts to the user interface.

11. The application function execution system of claim 8, wherein the plurality of data includes a source code and action correspondence that correlates a source code with the actions of the application, the AI system generates the code for the application corresponding to the action sequence based on the source code and action correspondence.

12. The application function execution system of claim 1, wherein the controller converts the code from the AI system into a user format and displays the user format on the user interface.

13. The application function execution system of claim 1, wherein the action sequence is one of a plurality of action sequences generated by the AI system based on the formatted input and contained in the code, the controller manages a queue of the plurality of action sequences and executes them on the application in a sequence received.

14. The application function execution system of claim 1, wherein the controller generates a reusable script based on the code from the AI system and stores the reusable script.

15. The application function execution system of claim 14, wherein the reusable script is directly executable by the controller to perform the function on the application without communicating with the AI system.

16. The application function execution system of claim 1, wherein the application is one of a plurality of applications that perform different functions from one another and that each communicate with the controller and the AI system, the controller executes the code on any one of the plurality of applications.

17. The application function execution system of claim 1, wherein the natural language input is an audio input or a text input in any of a plurality of different languages.

18. The application function execution system of claim 1, wherein the application, the user interface, and the controller are on a computing device, the computing device communicates with the AI system over a network.

19. The application function execution system of claim 1, wherein the application, the user interface, the controller, and the AI system are on a single computing device.

20. A method, comprising:
receiving a natural language input from a user at a user interface, the natural language input is an instruction to perform a function on an application;
generating a formatted input representative of the natural language input with a controller;
transmitting the formatted input from the controller to an AI system;
generating an action sequence based on the formatted input at the AI system;
generating a code for the application corresponding to the action sequence; and
executing the code on the application to perform the function corresponding to the natural language input.
